(19) United States
(12) Patent Application Publication
(10) Pub. No.: US 2015/0169422 A1
(43) Pub. Date: Jun. 18, 2015

(54) EVALUATION METHOD FOR CALIBRATION OF PROCESSING EQUIPMENT

(71) Applicant: METAL INDUSTRIES RESEARCH & DEVELOPMENT CENTRE, KAOHSIUNG CITY (TW)

(72) Inventors: FU-CHUAN HSU, KAOHSIUNG CITY (TW); YU-FU LIN, KAOHSIUNG CITY (TW); TSUNG-PIN HUNG, KAOHSIUNG CITY (TW); YU-TING LYU, KAOHSIUNG CITY (TW); ZHENG-HAN HUNG, KAOHSIUNG CITY (TW)

(73) Assignee: METAL INDUSTRIES RESEARCH & DEVELOPMENT CENTRE, KAOHSIUNG CITY (TW)

(21) Appl. No.: 14/105,712

(22) Filed: Dec. 13, 2013

(51) Int. Cl. G06F 11/26

(52) U.S. Cl. CPC G06F 11/26

(57) ABSTRACT

The present invention provides an evaluation method for calibration of a processing equipment. According to the present invention, prior to processing a device, a test member including the same thickness and material with the device is manufactured. Then, the processing equipment is used to process the device, the test member and form a micro-processing structure in the test member. Next, the status of the micro-processing structure in the test member is inspected for evaluating if the processing equipment should be calibrated. In this way, the size and shape accuracy of the formation micro-processing structures using the monitored processing equipment can be reasonably guaranteed.

### FIELD OF THE INVENTION

The present invention provides an evaluation method for calibration of a processing equipment. This invention presents an evaluation method for determining whether the processing equipment should be calibrated. In this way, the processing accuracy of the processing equipment can be guaranteed.

### BACKGROUND OF THE INVENTION

Currently, various devices may need to drill or cut a plurality of processing structures such as via holes, blind holes, irregularly shaped holes, or slots. The designs of present devices toward lighter and more compact, leading to miniaturization of the plurality of processing structures and making them micro-processing structures. In order to control the accuracy of the micro-processing structures of devices under process, there are several inspection methods for micro-processing structures have been developed. In the following, the inspection methods for micro holes are described. The first method is a destructive inspection method, which first dissects a micro hole of a device under process and exposes a half of the inner sidewall of the micro hole. Then a tool is used for measuring the realistic size and circularity of the micro hole. Alternatively, the hole shape is observed by bare eyes. Nonetheless, the above inspection method needs to destroy the micro hole and the device under process. Thereby, the device under process cannot be used and manufactured subsequently, leading to waste in labor and materials. Besides, the destructive inspection method cannot inspect hard and brittle materials.

Another method is the image extraction method, which adopts a CCD image sensor and the manual adjustable measurement device of a microscope for manually focusing and taking pictures above micro holes and thereby judging the top and bottom diameters of holes. The above destructive inspection method lacks inspection efficiency, particularly for micro holes inspection cases. It is difficult to acquire the size and shape of the central cross-section of a micro hole by the slicing method. In addition, the method is extremely time consuming and requires high cost; it is clumsy in controlling the yield of micro holes. The measurement device used in the image extraction method described above can only extract a single plane image of a micro hole. It cannot judge or stack for computing multi-plane three-dimensional images. For micro holes having three-dimensional shapes, it is hard to get realistic and accurate images. Hence, the method is disadvantageous in judging the realistic and accurate size of micro holes.

In general, the processing equipment produces a lost accuracy in micro structure processing due to the lacks of calibrating the processing equipment accurately. Thereby, using the non-accurate calibration processing equipment to process the device, the formed micro-processing structure in the device will not accurate in size. Accordingly, the present invention provides an evaluation method for calibration of a processing equipment for improving the problems described above effectively. According to the present invention, prior to processing, the processing equipment is evaluated for calibration. Thereby, when the processing equipment processes a device under process, it is guaranteed that the micro-processing structures formed in the device under process can have accurate size and shape.

### SUMMARY

The objective of the present invention is to provide an evaluation method for calibration of a processing equipment. This invention presents a method for determining the work conditions of processing equipment. In this method, the processing equipment can be monitored and maintained in good work conditions. Thereby, when the processing equipment processes a device under process, it is guaranteed that a micro-processing structure formed in the device under process can have accurate size and shape.

Another objective of the present invention is to provide an evaluation method for calibration of a processing equipment. According to the present invention, a test member is used for simulating a device under process. The processing equipment processes the test member and forming a micro-processing structure in the test member for simulating the processing equipment processing the device under process and forming a micro-processing structure in the device under process. Then the status of the micro-processing structure in the test member is inspected for evaluating if the processing equipment should be calibrated. Thereby, the accuracy of evaluation can be enhanced efficiently.

Still another objective of the present invention is to provide an evaluation method for calibration of a processing equipment. According to the present invention, the test member is formed by stacking a plurality of test slices. For inspecting the status of the micro-processing structure in the test member, the plurality of test slices are separated and a test slice is selected as the inspection target. Then the micro-processing structure in the inspection target is inspected for rapid inspection and reducing inspection cost. Thereby, the inspection accuracy is further improved and hence enhancing the accuracy of evaluation.

To achieve the above objectives and effects, the present invention provides an evaluation method for calibration of a processing equipment. The invention comprises the steps of providing a test member having a plurality of test slices; providing a processing equipment for processing the test member and forming a micro-processing structure in the test member; separating the plurality of test slices, inspecting the status of the micro-processing structure in each test slice, and producing an inspection result; and evaluating if the processing equipment should be calibrated regarding the inspection result.

### BRIEF DESCRIPTION OF THE DRAWINGS

FIG. 1 shows a flowchart of the evaluation method for calibration according to the first embodiment of the present invention;

FIG. 2 shows a schematic diagram of the step S10 according to the first embodiment of the present invention;

FIG. 3 shows a schematic diagram of the step S11 according to the first embodiment of the present invention;

FIG. 4 shows a schematic diagram of the micro-processing structure formed in the test member according to the first embodiment of the present invention;

FIG. 5 shows a schematic diagram of separating the test member according to the first embodiment of the present invention;

FIG. 6 shows a schematic diagram of processing the test member according to the second embodiment of the present invention; and

FIG. 7 shows a schematic diagram of separating the test member according to the second embodiment of the present invention.

### DETAILED DESCRIPTION

In order to make the framework and characteristics as well as the effectiveness of the present invention to be further understood and recognized, the detailed description of the present invention is provided as follows along with embodiments and accompanying figures.

According to the prior art, a non-calibrated processing equipment will result in inaccurate size and shape of the micro-processing structure in the device under process. When this happens, it is required to have post processes for repairing the micro-processing structure of the device under process. Even worse, the device under process might be discarded and unusable. Thereby, the manufacturing cost is increased. The present invention provides an evaluation method for calibration of a processing equipment. This invention presents a method for determining the work conditions of processing equipment. In this method, the processing equipment can be monitored and maintained in good work conditions Thereby, when the processing equipment processes a device under process, it is guaranteed that a micro-processing structure formed in the device under process can have accurate size and shape.

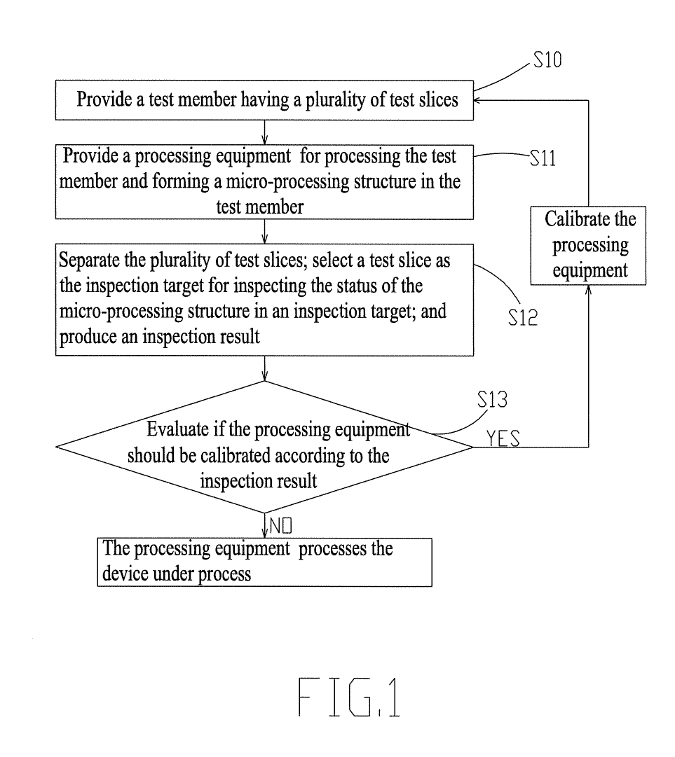

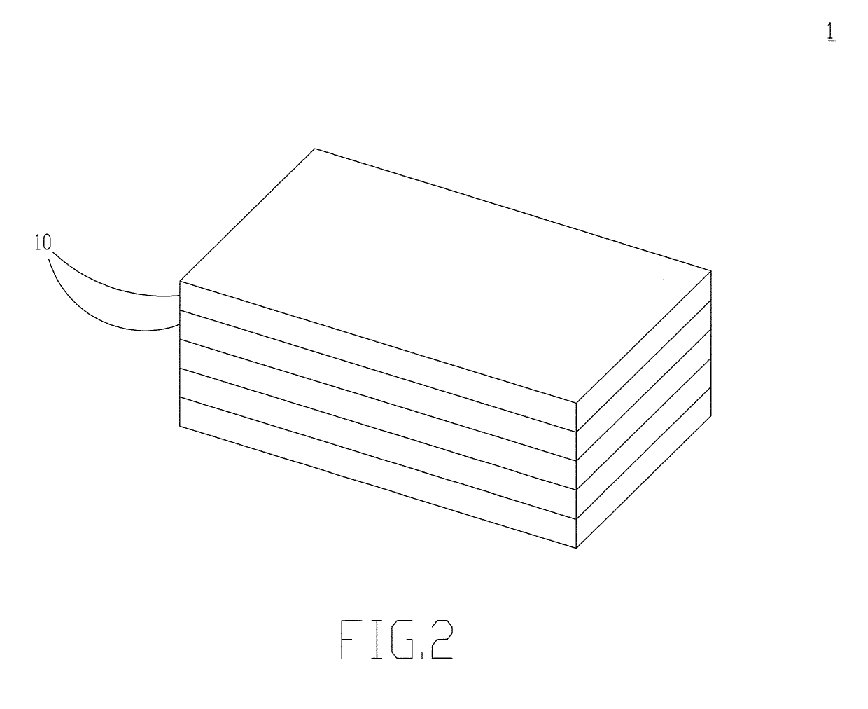

Please refer to FIG. 1 and FIG. 2, which show a flowchart of the evaluation method for calibration and a schematic diagram of the step S10 according to the first embodiment of the present invention. As shown in the figures, the present embodiment provides an evaluation method for calibration of a processing equipment. First, the step S10 is executed for providing a test member 1. The test member 1 has a plurality of test slices 10 stacked to form the test member 1. The test member 1 according to the present embodiment is used for simulating the device under process processed by the processing equipment. Thereby, the thickness and the material of the test member 1 are identical to those of the device under process. By making the micro-processing structure formed by processing the test member 1 by the processing equipment identical or similar to the micro-processing structure formed by processing the device under process by the processing equipment, the evaluation result will be accurate.

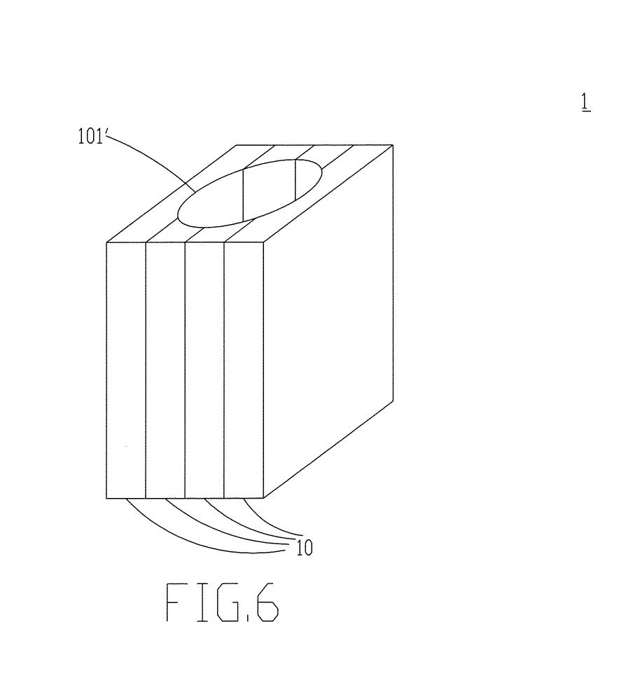

The test member 1 is formed by stacking the plurality of test slices 10, which adopt slice-shaped materials directly. Alternatively, the plurality of test slices 10 can be formed by slicing bulk materials. The details will not be described further. In addition, the test member 1 is formed by stacking the plurality of test slices 10 and the thickness of the test member 1 is made to be identical to the thickness of the device under process. For example, if the thickness of the device under process is 10 centimeters. The test member 1 according to the present embodiment adopts five slices of test slices 10 for stacking. Thereby, the thick of each test slice 10 is 2 centimeters. Then the test slices 10 represent the statuses of the device under process at the locations with depths 2, 4, 6, 8, and 10 centimeters, respectively. Of course, the thicknesses of the plurality of test slices 10 can be made different from one another, depending on the locations to be inspected by the user. For example, if the user needs to inspect the locations with depths 2, 5, and 10 centimeters only, the test member 1 can be formed by stacking a test slice 10 with the thickness of 2 centimeters, one with the thickness of 3 centimeters, and one with the thickness of 5 centimeters. The above description is only embodiments of the present invention. The combination of the plurality of test slices 10 can be determined according to the user's requirement. The details will not be described further. Moreover, the plurality of test slices 10 described above are attacked vertically. Nonetheless, the plurality of test slices 10 can be stacked horizontally. As shown in FIG. 6, the length or width of the test slices is just the thickness of the device under process.

When the test slices 10 are stacked, the surface of each test slice 10 contacts closely with the surfaces of the adjacent plurality of test slices 10. If the contact surfaces of the plurality of test slices 10 are uneven and forming gaps between the plurality of test slices 10, there will be differences between the micro-processing structures generated by processing the test member 1 formed by stacking the plurality of test slices 10 and the micro-processing structures generated by processing the bulk device under process, influencing the accuracy of subsequent evaluation. Thereby, the surface roughness of each test slice 10 is preferably less than 50 nanometers. If not, the surfaces of the test slices 10 can be ground for making the plurality of test slices 10 contact to one another tightly. Thus, gaps generated between the plurality of test slices 10 and influencing the evaluation accuracy can be avoided.

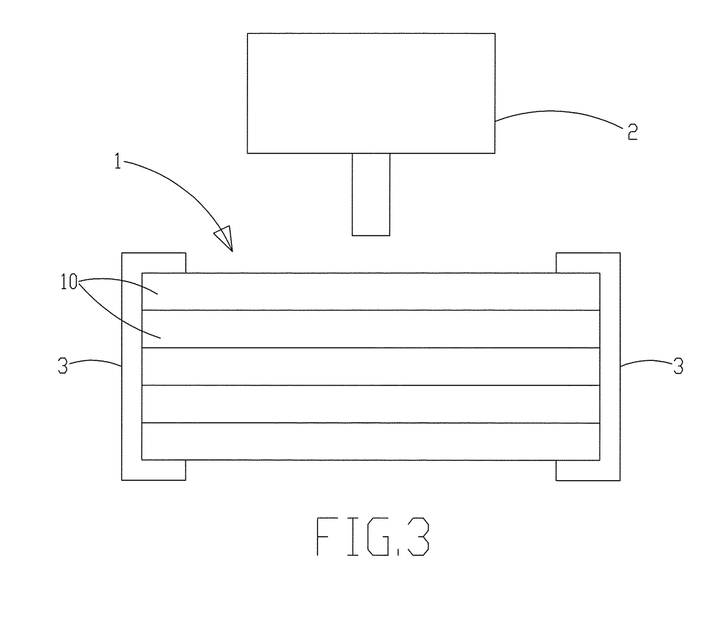

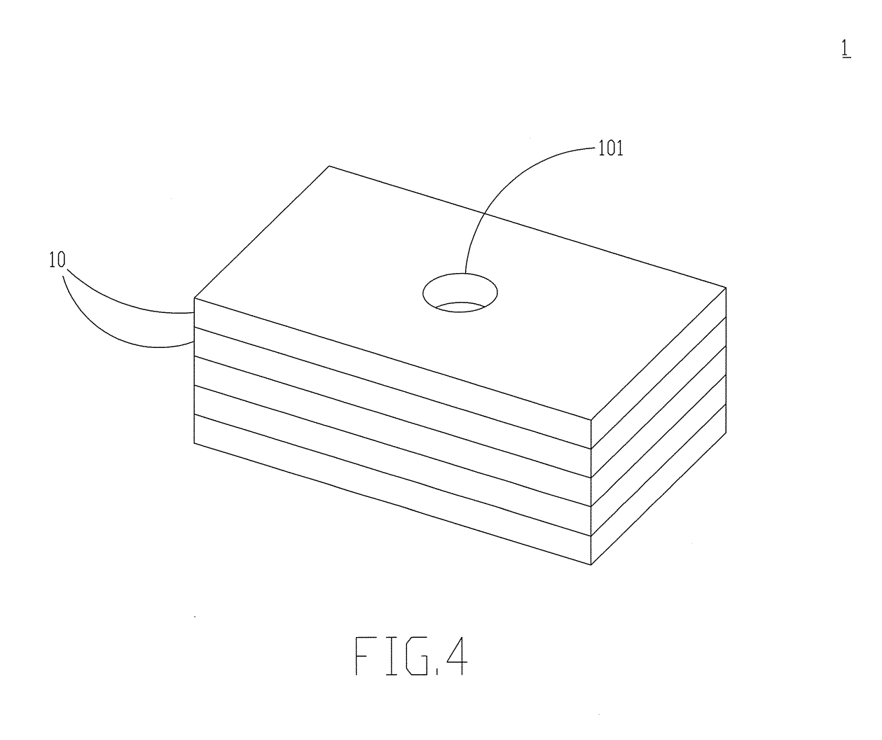

Please refer to FIG. 3 and FIG. 4, which show a schematic diagram of the step S11 and a schematic diagram of the micro-processing structure formed in the test member according to the first embodiment of the present invention. As shown in the figures, the step S11 is next executed for providing a processing equipment 2, which processes the test member 1 and Ruining the micro-processing structure 101 therein. The processing equipment 2 can be a discharge processing equipment, a laser processing equipment, a ultrasonic processing equipment, or a traditional processing equipment (such as a drill machine, a linear cutting machine, or a milling machine). Before the processing equipment 2 according to the present embodiment processes the test member 1, two clip members 3 are first used for clipping both sides of the test member 1. Each clip member 3 clips the top and bottom test slices 10 of the test member 1 and crosses the plurality of test slices 10 between the top and bottom test slices 10 of the test member 1 for clipping and fixing the plurality of test slices 10 and further preventing the plurality of test slices 10 from displacement during processing. The processing equipment 2 according to the present embodiment processes from the test slice 10 located at the top of the test member 1 to the one located at the bottom of the test member 1 and forms the micro-processing structure 101 in the test member 1. The micro-processing structure 101 passes through the plurality of test slices 10; each test slice 10 has a portion of the micro-processing structure 101. For example, the micro-processing structure 101 formed in the test member 1 by the processing equipment 2 is a circular micro hole. The micro-processing structure 101 passes through the plurality of test slices 10. Consequently, each test slice 10 has the circular micro hole as well.

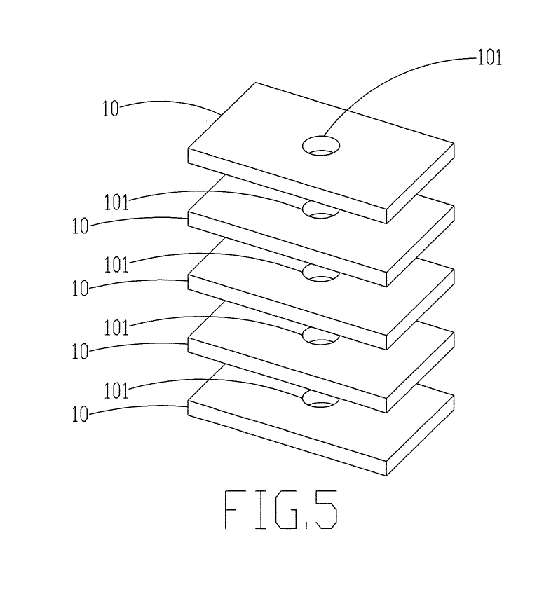

Please refer to FIG. 5, which shows a schematic diagram of separating the test member according to the first embodiment of the present invention. As shown in the figure, the step S12 is executed for disengaging the two clip members 3 and separating the plurality of test slices 10. In addition, a test slice 10 is selected as the inspection target for inspecting the status of the micro-processing structure 101 located in the inspection target and producing an inspection result. The inspection target can be the micro-processing structure 101 at a depth of the test member 1. Alternatively, the micro-processing structure 101 can be divided into several parts for easy inspection; no complicated inspection method, such as the destruction inspection method, is required. Thereby, the accuracy and efficiency of inspection are both improved. Each test slice 10 has a circular micro hole, which is just a portion of the micro-processing structure 101. If the micro-processing structure 101 is a circular micro hole, the diameters of the micro-processing structure 101 of the test member 1 from the top of the test member 1 to the bottom of the test member 1 are identical. Then, measure the diameter of the micro hole of at least a test slice 10, namely, the inspection target, and produce the inspection result according to the measurement data of the test slice 10. In addition to measuring the diameter of the micro hole of at least a test slice 10, the circularity of the micro hole of at least a test slice 10 can be measured as well. Alternatively, the status of the inner sidewall of at least a test slice 10 can be observed by bare eyes. The above results can also be the inspection result.

After the inspection result is produced, the step S13 is executed for evaluating if the processing equipment should be calibrated regarding the inspection result. If the diameter of the micro hole of the test slice 10, namely, the inspection target, does not comply with the requirement, it means that there may be an accuracy problem in the size of the micro-processing structure formed by processing the device under process by the processing equipment 2. Thereby, the processing equipment 2 must be calibrated. The method for calibrating the processing equipment 2 is to adjust the parameters of the processing equipment 2 or grinding the processing cutter of the processing equipment 2. Conversely, if the diameter of the micro hole of the test slice 10, namely, the inspection target, complies with the requirement, it means that there will be no accuracy problem in the size of the micro-processing structure formed by processing the device under process by the processing equipment 2. Consequently, the processing equipment 2 can process the device under process directly. After the processing equipment 2 is calibrated, the steps S10 to S13 can be repeated until calibration of the processing equipment 2 is completed.

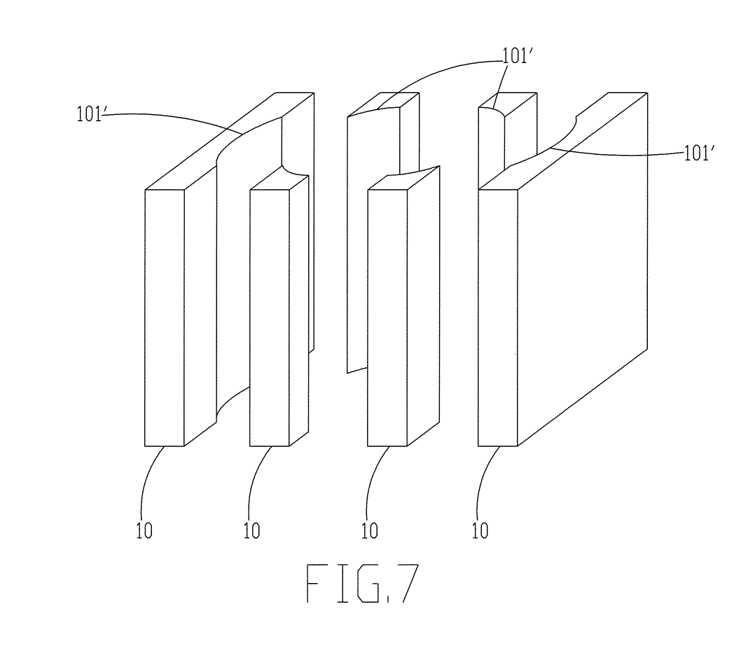

Please refer to FIG. 6 and FIG. 7, which show a schematic diagram of processing the test member and a schematic diagram of separating the test member according to the second embodiment of the present invention. As shown in the figures, the plurality of test members 1 according to the above embodiment is formed by stacking vertically the plurality of test slices 10. According to the present embodiment, the plurality of test slices 10 are stacked horizontally to form the test member 1. In this case, the processing equipment 2 processes between the plurality of test slices 10 for forming a micro-processing structure 101′ in the test member 1. For example, the processing equipment 2 processes the test member 1 and forms a circular micro hole (the micro-processing structure 101′) in the test member 1. Because the processing equipment 2 processes at the junctions of the plurality of test slices 10, each test slice 10 will not have a circular micro hole. Instead, curved grooves (a portion of the micro-processing structure 101′) are formed in each test slice 10. As the plurality of test slices 10 are separated, the status of the inner sidewall of a portion of the micro-processing structure 101′ in each test slice 10 can be inspected for producing the inspection result. Then, according to the inspection result, whether the processing equipment 2 should be calibrated can be evaluated.

To sum up, the present invention provides an evaluation method for calibration of a processing equipment. According to the present invention, before the processing equipment processes a device under process, the processing equipment processes a test member having the same thickness and material as the device under process and forming a micro-processing structure. By inspecting the status of the micro-processing structure in the test member, whether the processing equipment should be calibrated can be evaluated.

The evaluation method for calibration of a processing equipment according to the present invention adopts a test member having the same thickness and material as the device under process for testing. The micro-processing structure formed in the test member by the processing equipment is made identical or similar to the one formed in the device under process by the processing equipment. Thereby, if the accuracies in size and shape for the micro-processing structure formed in the test member by the processing equipment are bad, it means that the processing equipment cannot produce a micro-processing structure with excellent accuracies in size and shape. Thus, inspection of the status of the micro-processing structure in the test member is the reference for evaluation. Accordingly, the method is quite accurate, and improving the accuracy of evaluation effectively.

Furthermore, the evaluation method for calibration of a processing equipment according to the present invention adopts a plurality of stacked test slices. When the micro-processing structure is formed in the test member, the micro-processing structure is also formed in the plurality of test slices. Separation of the plurality of test slices divides the micro-processing structure into several parts with each part formed in the test slice. Thereby, each test slice can be inspected; it is not required to perform destructive, or other complicated, inspection on the plurality of test slices. Inspection is completed by simple measurement or bare-eye observation. Thereby, the overall inspection efficiency and accuracy can be enhanced. The evaluation accuracy is further improved as well.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An evaluation method for calibration of a processing equipment, comprising the steps of:
providing a test member, having a plurality of test slices;
providing a processing equipment, processing said test member and forming a micro-processing structure in said test member;
separating said plurality of test slices, selecting a test slice as an inspection target for inspecting the status of said micro-processing structure in said inspection target, and producing an inspection result; and
evaluating if said processing equipment should be calibrated regarding said inspection result.

2. The evaluation method for calibration of a processing equipment of claim 1, wherein if said processing equipment should be calibrated and after calibrating said processing equipment, said steps of providing said test member, said processing equipment processing said test member, separating said plurality of test slices, selecting a test slice as the inspection target for inspecting the status of said micro-processing structure in said inspection target, and evaluating if said processing equipment should be calibrated regarding said inspection result are repeated.

3. The evaluation method for calibration of a processing equipment of claim 1, wherein the surface roughness of the contact surface between each said test slice and the adjacent test slices is less than 50 nanometers.

4. The evaluation method for calibration of a processing equipment of claim 1, wherein the thickness of each test slice is different or identical.

5. The evaluation method for calibration of a processing equipment of claim 1, wherein said plurality of test slices are stacked vertically.

6. The evaluation method for calibration of a processing equipment of claim 5, wherein said processing equipment processes said test member from the test slice located at the top of said test member to the test slice located at the bottom of said test member.

7. The evaluation method for calibration of a processing equipment of claim 1, wherein said plurality of test slices are stacked horizontally.

8. The evaluation method for calibration of a processing equipment of claim 7, wherein said processing equipment processes said test member between said plurality of test members.

9. The evaluation method for calibration of a processing equipment of claim 1, and further comprising a step of clipping both sides of said test member for fixing said plurality of test slices before said step of said processing equipment processing said test member.

10. The evaluation method for calibration of a processing equipment of claim 1, wherein inspecting the status of said micro-processing structure in said inspection target is to measure the size, the circularity, or the status of the inner sidewall of said micro-processing structure in said inspection target.
